(19) United States
(12) Patent Application Publication
(10) Pub. No.: US 2025/0069783 A1
(43) Pub. Date: Feb. 27, 2025

(54) CABLE

(71) Applicants: SUMITOMO ELECTRIC INDUSTRIES, LTD., Osaka (JP); AutoNetworks Technologies, Ltd., Mie (JP); Sumitomo Wiring Systems, Ltd., Mie (JP)

(72) Inventors: Takumi OOSHIMA, Tochigi (JP); Hirokazu KOMORI, Osaka (JP); Takahiro MURATA, Mie (JP)

(21) Appl. No.: 18/724,361

(22) PCT Filed: Feb. 1, 2022
(86) PCT No.: PCT/JP2022/003852

§ 371 Date: Jun. 26, 2024

(51) Int. Cl. H01B 11/10; B60R 16/023; H01B 7/00; H01B 7/18; H01B 7/32; H01B 7/38; H01B 9/00

(52) U.S. Cl. CPC H01B 11/1025; B60R 16/023; H01B 7/0009; H01B 7/1875; H01B 7/326; H01B 7/38; H01B 9/003

(57) ABSTRACT

A cable includes a plurality of covered electric wires and an outer sheath, wherein the plurality of covered electric wires include two first covered electric wires, two second covered electric wires having a larger conductor cross-sectional area than the first covered electric wires, and two third covered electric wires having a smaller conductor cross-sectional area than the second covered electric wires, and wherein the two first covered electric wires are twisted together along a longitudinal direction thereof to form a first twisted wire pair, the two third covered electric wires are twisted together along a longitudinal direction thereof to form a second twisted wire pair, a twist pitch of the second twisted wire pair is longer than a twist pitch of the first twisted wire pair, the first twisted wire pair, the two second covered electric wires, and the second twisted wire pair are twisted together to form a core, in the core, at least a partial contact is provided between the first covered electric wires and the second covered electric wires, between the second covered electric wires and the third covered electric wires, and between the two first covered electric wires, and the outer sheath is arranged to cover the core.

### TECHNICAL FIELD

The present disclosure relates to cables.

### BACKGROUND ART

Patent Document 1 discloses a cable for an electric brake provided with at least one power supply line for supplying power to a motor serving as a braking source for an electric brake of a vehicle such as an automobile and at least one signal line for transmitting signals related to the control of the motor.

The disclosed cable for an electric brake is characterized by including at least one wire-breakage detection line which is arranged alongside, and in parallel to, the power supply line and the signal line, or is combined with, and helically wound around, a relevant line. The cable is configured to be severed prior to the breakage of the power supply line or the signal line, and is coated with insulation.

### RELATED ART DOCUMENT

### Patent Document

Patent Document 1: Japanese Patent Publication No. 2005-166450

### SUMMARY OF INVENTION

A cable according to the present disclosure includes a plurality of covered electric wires and an outer sheath,
wherein the plurality of covered electric wires include:
two first covered electric wires;
two second covered electric wires having a larger conductor cross-sectional area than the first covered electric wires; and
two third covered electric wires having a smaller conductor cross-sectional area than the second covered electric wires, and
wherein the two first covered electric wires are twisted together along a longitudinal direction thereof to form a first twisted wire pair,
the two third covered electric wires are twisted together along a longitudinal direction thereof to form a second twisted wire pair,
a twist pitch of the second twisted wire pair is longer than a twist pitch of the first twisted wire pair,
the first twisted wire pair, the two second covered electric wires, and the second twisted wire pair are twisted together to form a core,
in the core, at least a partial contact is provided between the first covered electric wires and the second covered electric wires, between the second covered electric wires and the third covered electric wires, and between the two first covered electric wires, and
the outer sheath is arranged to cover the core.

### BRIEF DESCRIPTION OF DRAWINGS

FIG. 1 is a cross-sectional view of a cable according to one aspect of the present disclosure in a plane perpendicular to the longitudinal direction.

FIG. 2 is a cross-sectional view of a cable according to one aspect of the present disclosure in a plane perpendicular to the longitudinal direction.

FIG. 3 is a drawing illustrating a twist pitch.

FIG. 4 is a drawing illustrating a bend count detection device.

### MODES FOR CARRYING OUT THE INVENTION

### Problems to be Solved by the Present Disclosure

A cable for controlling and braking an automobile, for example, needs to be replaced before the occurrence of wire breakage due to debilitation.

The object of the present disclosure is to provide a cable which allows the number of bends applied thereto to be counted.

### Effect of the Present Disclosure

According to the present disclosure, a cable which allows the number of bends applied thereto to be counted can be provided.

Embodiments will be described in the following.

### Description of Embodiments of the Present Disclosure

Embodiments of the present disclosure will first be listed with descriptions thereof. In the following description, the same or corresponding elements will be referred to by the same reference numerals, and duplicate descriptions thereof will not be given.

(1) A cable according to one aspect of the present disclosure includes a plurality of covered electric wires and an outer sheath,
wherein the plurality of covered electric wires include:
two first covered electric wires;
two second covered electric wires having a larger conductor cross-sectional area than the first covered electric wires; and
two third covered electric wires having a smaller conductor cross-sectional area than the second covered electric wires, and
wherein the two first covered electric wires are twisted together along a longitudinal direction thereof to form a first twisted wire pair,
the two third covered electric wires are twisted together along a longitudinal direction thereof to form a second twisted wire pair,
a twist pitch of the second twisted wire pair is longer than a twist pitch of the first twisted wire pair,
the first twisted wire pair, the two second covered electric wires, and the second twisted wire pair are twisted together to form a core,
in the core, at least a partial contact is provided between the first covered electric wires and the second covered electric wires, between the second covered electric wires and the third covered electric wires, and between the two first covered electric wires, and
the outer sheath is arranged to cover the core.

The third covered electric wires may be used as bend detection lines for detecting the bending of the cable. The bending of the cable may be detected by a change in the impedance of the two third covered electric wires. By making the twist pitch of the second twisted wire pair longer than the twist pitch of the first twisted wire pair, the distance between the two third covered electric wires increases when the cable is bent. This arrangement causes a change in the impedance of the second twisted wire pair to increase, thereby allowing the bending of the cable to be detected with high accuracy. The time of replacement of the cable can also be known from the number of bends applied to the cable. Specifically, the number of bends applied to the cable eventually reaches a predetermined threshold bend count, which results in a determination that the time of replacement has arrived, and the cable may then be replaced with a new one. The threshold bend count is determined such that the cable can be replaced before the cable breaks, for example.

(2) A twist direction of the second twisted wire pair may be different from a twist direction of the core.

Since the twist direction of the second twisted wire pair is different from the twist direction of the core, a gap that develops between the two third covered electric wires upon the bending of the wire becomes wide, which allows the bending of the cable to be accurately detected.

(3) The twist pitch of the second twisted wire pair may be longer than the twist pitch of the core.

By making the twist pitch of the second twisted wire pair longer than the twist pitch of the core, a gap that develops between the two third covered electric wires upon the bending of the wire becomes wide, which allows the bending of the cable to be accurately detected.

(4) The twist pitch of the second twisted wire pair may be greater than or equal to 50 times the outer diameter of each of the third covered electric wires.

By setting the twist pitch of the second twisted wire pair to 50 or more times the outer diameter of each of the third covered electric wires, the gap that develops between the two third covered electric wires upon the bending of the cable becomes sufficiently wide relative to the outer diameter of each of the third covered electric wires. It is thus possible to accurately detect the bending of the cable.

(5) A cable according to one aspect of the present disclosure includes a plurality of covered electric wires and an outer sheath;
wherein the plurality of covered electric wires include:
two first covered electric wires;
two second covered electric wires having a larger conductor cross-sectional area than the first covered electric wires; and
two third covered electric wires having a smaller conductor cross-sectional area than the second covered electric wires, and
wherein the two first covered electric wires are twisted together along a longitudinal direction thereof to form a first twisted wire pair, and
the first twisted wire pair, the two second covered electric wires, and the two third covered electric wires are twisted together to form a core,
wherein in the core,
the two third covered electric wires are arranged in substantially parallel, and
at least a partial contact is provided between the first covered electric wires and the second covered electric wires, between the second covered electric wires and the third covered electric wires, and between the two first covered electric wires, and
wherein the outer sheath is arranged to cover the core.

The third covered electric wires may be used as bend detection lines for detecting the bending of the cable. The bending of the cable may be detected by a change in the impedance of the two third covered electric wires. By arranging the two third covered electric wires in substantially parallel, the distance between the two third covered electric wires increases when the cable is bent. This arrangement causes a change in the impedance of the two third covered electric wires to increase, thereby allowing the bending of the cable to be detected with high accuracy. The time of replacement of the cable can also be known from the number of bends applied to the cable. Specifically, the number of bends applied to the cable eventually reaches a predetermined threshold bend count, which results in a determination that the time of replacement has arrived, and the cable may then be replaced with a new one. The threshold bent count is determined such that the cable can be replaced before the cable breaks, for example.

(6) In a cross-section perpendicular to a longitudinal direction,
when the cross-section is divided into a first region and a second region by a straight line connecting centers of the two second covered electric wires,
the two first covered electric wires may be arranged in the first region and the third covered electric wires may be arranged in the second region.

By arranging the first covered electric wires and the third covered electric wires in the two respective regions separated by the straight line connecting the centers of the two second covered electric wires, the cable can be rounded.

(7) Each of the aforementioned cables includes a shield layer covering the core, and
the outer sheath may be arranged to cover the shield layer.

The provision of the shield layer serves to reduce signal leakage to the outside and radio wave intrusion from the outside.

(8) Each of the aforementioned cables may include a release material disposed outside the core.

The provision of the release material on the outer surface of the core allows the core and the outer sheath to be prevented from coming into direct contact with each other, so that the outer sheath may be easily separated when the covered electric wires are taken out of the cable.

### Details of Embodiments of the Present Disclosure

Specific examples of a cable and a bend count detecting apparatus according to embodiments of the present disclosure (hereinafter referred to as “present embodiments”) will be described below with reference to the drawings. It should be noted that the present invention is not limited to these examples, but is intended to be defined by the scope of the claims and to include all modifications within the meaning and scope equivalent to the scope of the claims.

### (1) Cable

### (1-1) First Embodiment

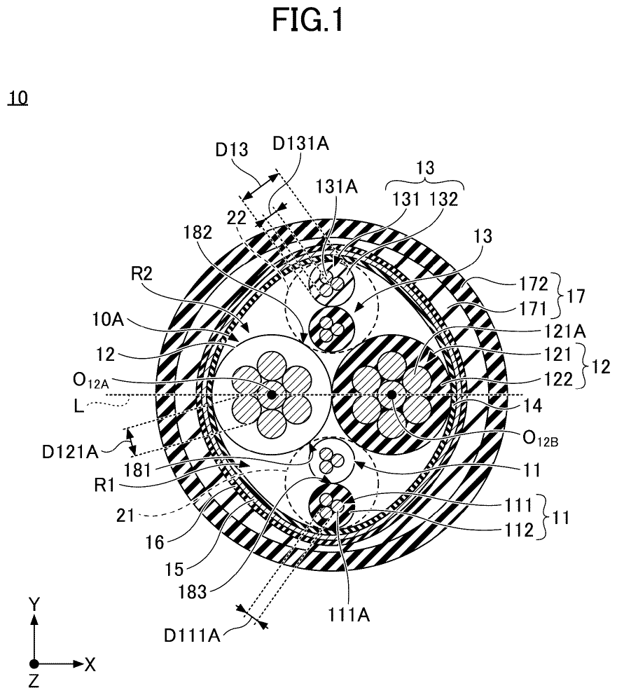

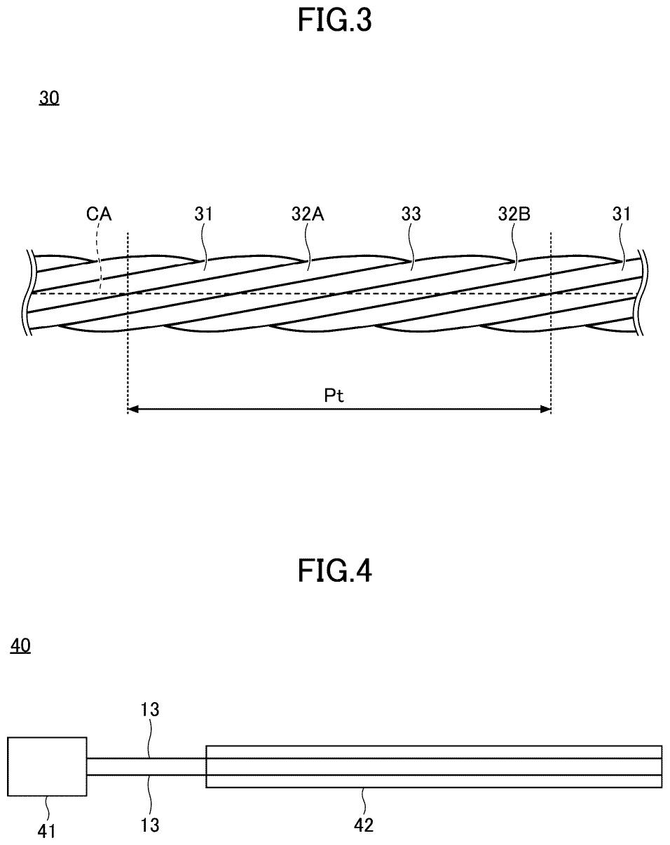

A cable of the present embodiment will be described with reference to FIG. 1 and FIG. 3.

FIG. 1 illustrates a cross-sectional view of a cable 10 of the present embodiment in a plane perpendicular to the longitudinal direction. FIG. 3 is a drawing illustrating a twist pitch. In FIG. 1, the Z-axis direction, i.e., the direction perpendicular to the paper plane, is the longitudinal direction of the cable or covered electric wires, and the XY plane is the plane perpendicular to the longitudinal direction of the cable or the like.

As illustrated in FIG. 1, the cable 10 of the present embodiment includes a plurality of covered electric wires and an outer sheath 17.

The cable 10 illustrated in FIG. 1 may include two first covered electric wires 11, two second covered electric wires 12, and two third covered electric wires 13 as the plurality of covered electric wires. The two first covered electric wires 11 may be constituted by the same members, and may have the same conductor cross-sectional area and the like, which will be described later. The same applies to the two second covered electric wires 12 and the two third covered electric wires 13.

In the following, the members of the cable 10 of the present embodiment will be described.

### (1-1-1) Covered Electric Wire

(First Covered Electric Wire through Third Covered Electric Wire)

Covered electric wires are electric wires that perform functions required in equipment or the like for power supply, voltage application, communication, etc.

Each covered electric wire may include a conductor that is a twisted strand of a plurality of element conductor wires and an insulator that covers the outer periphery of the conductor.

Each first covered electric wire 11 includes a conductor 111 that is a twisted strand of element conductor wires 111A and an insulator 112 that covers the outer periphery of the conductor 111. The first covered electric wires 11 may be signal lines, for example.

Each second covered electric wire 12 includes a conductor 121 that is a twisted strand of element conductor wires 121A, and an insulator 122 that covers the outer periphery of the conductor 121. The second covered electric wires 12 may have a larger conductor cross-sectional area than the first covered electric wires 11. The second covered electric wires 12 may be power supply lines, for example.

Each third covered electric wire 13 includes a conductor 131 that is a twisted strand of element conductor wires 131A, and an insulator 132 that covers the outer periphery of the conductor 131. The third covered electric wires 13 may have a smaller conductor cross-sectional area than the second covered electric wires 12. The third covered electric wires 13 may be bend detection lines for detecting the bending of the cable 10 in order to count the number of bends of the cable 10.

(Example of Configuration of First Covered Electric Wire through Third Covered Electric Wire)

The diameter and the number of element conductor wires constituting the conductor of any given covered electric wire may be selected according to the electrical characteristics required for this covered electric wire.

For the first covered electric wire 11, the diameter D111A of the element conductor wire 111A is preferably 0.05 mm to 0.16 mm inclusive, and more preferably 0.05 mm to 0.10 mm inclusive.

For the first covered electric wire 11, the element conductor wires 111A may be twisted in multiple levels to form the conductor 111. That is, the conductor 111 of the first covered electric wire 11 may include a first twisted strand (a child twisted strand) made by twisting the element conductor wires 111A and a second twisted strand (a parent twisted strand) made by twisting a plurality of first twisted strands. A twisted strand made by further twisting a plurality of second twisted strands may alternatively serve as the conductor 111. The element conductor wire 111A of the first covered electric wire 11 may also be twisted in a single level.

For the second covered electric wire 12, the diameter D121A of the element conductor wire 121A is preferably 0.05 mm to 0.16 mm inclusive, and more preferably 0.05 mm to 0.10 mm inclusive. For the second covered electric wire 12, the element conductor wires 121A may be twisted in multiple levels to form the conductor 121. It thus follows that, for example, the conductor 121 of the second covered electric wire 12 may include a first twisted strand (a child twisted strand) made by twisting the element conductor wires 121A and a second twisted strand (a parent twisted strand) made by twisting a plurality of first twisted strands. The second twisted strand may be used as the conductor 121, or a twisted strand obtained by further twisting a plurality of second twisted strands may be used as the conductor 121.

For the third covered electric wire 13, the diameter D131A of the element conductor wire 131A is preferably 0.05 mm to 0.16 mm inclusive, and more preferably 0.05 mm to 0.10 mm inclusive.

For the third covered electric wire 13, the element conductor wires 131A may be twisted in multiple levels to form the conductor 131. That is, the conductor 131 of the third covered electric wire 13 may include a first twisted strand (a child twisted strand) made by twisting the element conductor wires 131A and a second twisted strand (a parent twisted strand) made by twisting a plurality of first twisted strands. The conductor 131 may alternatively be a twisted strand made by further twisting a plurality of second twisted strands. The element conductor wire 131A of the third covered electric wire 13 may also be twisted in a single level.

The diameter of an element wire such as an element conductor wire or the like may be measured and calculated by the following procedure as an example.

First, the diameters of an element wire are measured by a micrometer along two orthogonal diameters of the element wire in any single cross-section perpendicular to the longitudinal direction of the element wire. Then, the average value thereof may be taken as the diameter of the element wire. In the instant specification, the diameter of an element wire may be measured and calculated in substantially the same manner.

One example configuration may be such that the cross-sectional area of the conductor 121 of the second covered electric wire 12 is 1.5 mm² or more and 3.0 mm² or less. In this case, an example configuration may be such that the cross-sectional area of the conductor of each of the first covered electric wire 11 and the third covered electric wire 13 is 0.05 mm² or more and 0.5 mm- or less.

The cross-sectional area of the conductor of each of the first covered electric wire 11 and the third covered electric wire 13 is preferably smaller than the cross-sectional area of the conductor of the second covered electric wire 12. The cross-sectional area of the conductor of the second covered electric wire 12 is more preferably greater than or equal to 3 times, and less than or equal to 15 times, the cross-sectional area of the conductor of each of the first covered electric wire 11 and the third covered electric wire 13.

The material of the element conductor wires of the first covered electric wire 11 through the third covered electric wire 13 is not limited to a particular one, but the examples include copper, aluminum, copper alloy, aluminum alloy, and the like. The element conductor wire may have a surface plated with silver or tin. For this reason, silver plated copper alloy, tin plated copper alloy, or the like may be used as a material of the element conductor wires.

Although the material of the insulator is not limited to a particular one, one or more kinds of resin selected from fluororesin such as polytetrafluoroethylene (PTFE), tetrafluoroethylene-perfluoroalkyl vinyl ether copolymer (PFA), tetrafluoroethylene-hexafluoropropylene copolymer (FEP), and ethylene-tetrafluoroethylene copolymer (ETFE), polyester resin such as polyethylene terephthalate (PET), polyolefin resin such as polyethylene and polypropylene, and the like may be used. The resin of the insulator may or may not be cross-linked.

In addition to the resin, the insulator may contain additives such as a flame retardant, a flame-retardant aid, an antioxidant, a lubricant, a colorant, a reflective material, a concealing agent, a processing stabilizer, and a plasticizer.

The materials of the members constituting a wire may be the same or different among the first covered electric wire 11, the second covered electric wire 12, and the third covered electric wire 13.

### (First Twisted Wire Pair and Second Twisted Wire Pair)

The two first covered electric wires 11 may be helically twisted together along the longitudinal direction to form a first twisted wire pair 21.

The two third covered electric wires 13 may be helically twisted together along the longitudinal direction to form a second twisted wire pair 22.

By twisting together two covered electric wires of the same kind to form a twisted wire pair as noted above, signals transmitted through the cable are not easily affected by noise, for example.

The twist pitch of the second twisted wire pair 22 is preferably longer than the twist pitch of the first twisted wire pair 21.

Twist pitch will now be described with reference to FIG. 3.

Twist pitch refers to the length over which the wires constituting a twisted strand is twisted one turn. Here, the length refers to the length along the central axis of a twisted strand 30.

FIG. 3 is a side view of the twisted strand 30. The twisted strand 30 serves as the core 10A of the cable 10 or a core 20A of a cable 20. Accordingly, the twisted strand 30 includes a first covered electric wire 31, a second covered electric wire 32A, a second covered electric wire 32B, and a third covered electric wire 33. On the side surface of the twisted strand 30, the first covered electric wire 31, the second covered electric wire 32A, the third covered electric wire 33, and the second covered electric wire 32B appear alternately in this order. The first covered electric wire and the third covered electric wire may each be a twisted wire pair, but the twist is omitted from illustration in FIG. 3.

As illustrated in FIG. 3, the distance between the turns of the same wire on a central axis CA, for example, between the turns of the first covered electric wire 31, on the side surface of the twisted strand 30 becomes the twist pitch Pt of the twisted strand 30.

As described above, the third covered electric wires 13 constituting the second twisted wire pair 22 may be used as bend detection lines to detect the bending of the cable 10. The bending of the cable 10 may be detected by a change in the impedance of the two third covered electric wires 13. By making the twist pitch of the second twisted wire pair 22 longer than the twist pitch of the first twisted wire pair 21, the distance between the two third covered electric wires 13 increases when the cable 10 is bent, which causes the change in the impedance of the second twisted wire pair to increase. That is, the impedance of the second twisted wire pair change by a significant amount. With this arrangement, the bending of the cable 10 may be accurately detected from the change in impedance of the second twisted wire pair. The time of replacement of the cable can also be known from the number of bends applied to the cable. Specifically, the number of bends applied to the cable eventually reaches a predetermined threshold bend count, which results in a determination that the time of replacement has been reached, and the cable may then be replaced with a new one. The threshold bend count is determined such that the cable can be replaced before the cable breaks, for example.

The twist pitch of the second twisted wire pair 22 is preferably greater than equal to 50 times the outer diameter D13 of the third covered electric wire 13, and more preferably greater than or equal to 60 times the outer diameter.

By setting the twist pitch of the second twisted wire pair 22 to 50 or more times the outer diameter D13 of the third covered electric wires 13, the gap that develops between the two third covered electric wires 13 upon the bending of the cable 10 becomes sufficiently wide relative to the outer diameter of the third covered electric wires 13. It is thus possible to accurately detect the bending of the cable 10.

The upper limit of the ratio of the twist pitch of the second twisted wire pair 22 to the outer diameter D13 of the third covered electric wires 13 is not limited to a particular value, but is preferably, for example, 90 times or less, and more preferably 120 times or less.

The twist pitch of the second twisted wire pair 22 is preferably, for example, 60 mm to 150 mm inclusive, and more preferably 80 mm to 120 mm inclusive.

The twist pitch of the first twisted wire pair 21 is preferably, for example, 20 mm to 60 mm inclusive, and more preferably 25 mm to 50 mm inclusive.

### (Core)

For the cable 10, the first twisted wire pair 21, the two second covered electric wires 12, and the second twisted wire pair 22 are twisted, specifically, helically twisted along the longitudinal direction, to form the core 10A.

Although the arrangement of the plurality of covered electric wires constituting the core 10A is not limited to a particular one, the core 10A may preferably be such that at least a partial contact is provided between the first covered electric wires 11 and the second covered electric wires 12, between the second covered electric wires 12 and the third covered electric wires 13, and between the two first covered electric wires 11. In FIG. 1, for example, the first covered electric wires 11 and the second covered electric wires 12 are preferably in contact with each other at a contact point 181. The second covered electric wires 12 and the third covered electric wires 13 are preferably in contact with each other at a contact point 182. The first covered electric wires 11 are preferably in contact with each other at a contact point 183.

There is no need for the contact to be kept throughout the entirety of the length of the cable 10, but it suffices for the covered electric wires to be at least partially in contact with each other along the longitudinal direction.

Since at least a partial contact is provided between the first covered electric wires 11 and the second covered electric wires 12, between the second covered electric wires 12 and the third covered electric wires 13, and between the two first covered electric wires 11, the diameter of the core 10A may be made small.

When the cross-section is divided into a first region R1 and a second region R2 by a straight line L connecting the centers O_{12A} and O_{12B} of the two second covered electric wires 12 in a cross-section perpendicular to the longitudinal direction of the cable 10, the two first covered electric wires 11 are preferably arranged in the first region R1. Further, the two third covered electric wires 13 are preferably arranged in the second region R2.

As described above, the outer periphery of the core 10A may be rounded by arranging the first and third covered electric wires 11 and 13 in two respective regions separated by the straight line connecting the centers O_{12A} and O_{12B} of the two second covered electric wires 12. That is, the outer shape of the cable may be rounded. When a cable is inserted into a device, the inlet port may be sealed to prevent water from entering the device through the inlet port. The provision of a round outer shape, i.e., an approximately circular outer shape, for the cable makes it easier to seal the cable securely.

Although the twist direction of the core 10A is not limited to a particular one, the twist direction of the second twisted wire pair 22 is preferably different from, i.e., opposite to, the twist direction of the core 10A.

With the twist direction of the second twisted wire pair 22 being different from the twist direction of the core 10A, the gap that develops between the two third covered electric wires 13 upon the bending of the cable 10 becomes wide, which allows the bending of the cable 10 to be accurately detected.

Preferably, the twist pitch of the second twisted wire pair 22 is longer than the twist pitch of the core 10A.

By making the twist pitch of the second twisted wire pair 22 longer than the twist pitch of the core 10A, the gap that develops between the two third covered electric wires 13 upon the bending of the cable 10 becomes wide, which allows the bending of the cable 10 to be accurately detected.

The twist pitch of the core 10A is not limited to a particular one, and is preferably, for example, 60 mm to 150 mm inclusive, and more preferably 70 mm to 120 mm inclusive.

### (1-1-2) Cover

The cable 10 may include the outer sheath 17 arranged to cover the core 10A. The outer sheath 17 may be formed as an extrusion molding of an insulator which has, for example, a polymer material as a main component, and may constitute the outermost periphery of the cable 10. Alternatively, the outer sheath may be manufactured as a hollow tube and the core may be passed through the hollow space inside the outer sheath.

The structure of the outer sheath 17 is not limited to a particular one and may consist of, for example, one or more layers. As illustrated in FIG. 1, for example, the outer sheath 17 may be implemented as a two-layer structure with an inner layer 171 and an outer layer 172. In this case, the outer layer 172 disposed at the outermost periphery is preferably made of a material having better mechanical characteristics such as abrasion resistance than the inner layer 171. The outer sheath 17 may be formed by laminating two outer sheath layers made of the same material. In this case, combining the two outer sheath layers makes it impossible to determine, from the outer appearance, whether only one layer exists or two layers exist. Such a configuration falls within the scope of the cable of the present embodiment.

Although the material of the outer sheath 17 is not limited to a particular one, when the outer sheath 17 includes the inner layer 171 and the outer layer 172 as illustrated in FIG. 1, the inner layer 171 may contain one or more kinds selected from polyolefins such as polyethylene and ethylene-vinyl acetate copolymer (EVA), polyurethane elastomer, polyester elastomer, etc., as resin components.

The outer layer 172 is disposed on the outermost surface of the cable 10, and, thus, is preferably made of a material excellent in scratch resistance and abrasion resistance, and may contain, for example, polyurethane or the like as a resin component.

The resin component of the outer sheath 17 may or may not be cross-linked.

The outer sheath 17 may also contain additives such as a flame retardant, a flame-retardant aid, an antioxidant, a lubricant, a colorant, a reflective material, a concealing agent, a processing stabilizer, a plasticizer, a crosslinking aid and the like in addition to the above-noted resin component.

### (1-1-3) Interposition

The cable 10 of the present embodiment may also include an interposition 14. In this case, the interposition 14 may be located between the core 10A and the outer sheath 17.

The interposition 14 may be a tape member such as a string, resin, nonwoven fabric, or paper.

The provision of the interposition 14 allows the outer shape of the cable to be rounded, i.e., to be close to a perfect circle.

### (1-1-4) Shield Layer

As illustrated in FIG. 1, the cable 10 of the present embodiment may have a shield layer 15 covering the core 10A outside the core 10A. When the cable 10 has the interposition 14, the shield layer 15 may be arranged to cover the interposition 14. The outer sheath 17 is arranged to cover the shield layer 15.

The shield layer 15 may be composed of a conductive material.

For example, the shield layer 15 may be formed by helically winding a conductive tape containing a conductive layer along the longitudinal direction of the core 10A.

In this case, the conductive tape may have a conductive layer on the upper or lower surface of the substrate. The conductive tape may have a conductive layer on both the upper and lower surfaces of the substrate.

The material of the conductive layer is not limited to a particular one, but preferably contains metal, and may be, for example, a metal foil. When the conductive layer contains metal, the material of the metal is not limited to a particular one, but may be, for example, copper, copper alloy, aluminum, aluminum alloy, or the like.

The material of the substrate is also not limited to a particular one, but is preferably made of an insulating material such as an organic polymer material or a nonwoven fabric. Examples of the organic polymer material include a polyester resin such as polyethylene terephthalate (PET), a polyolefin resin such as polypropylene, and a vinyl resin such as polyvinyl chloride. The substrate may be a substrate containing an insulating material, or may be a substrate made of an insulating material alone.

When the conductive tape is wound to form the shield layer 15 as described above, the winding direction of the conductive tape may be freely selected. For example, the winding direction may be the same direction as, or a different direction from, the twist direction of the core 10A previously described. In particular, the twist direction of the core 10A and the winding direction of the conductive tape are preferably in the same direction.

The shield layer 15 may alternatively be composed of metallic wires. Copper, aluminum, copper alloy, or the like may be used as the material of the metallic wires. The surface of the metallic wires may be plated with silver or tin. It thus follows that, for example, a silver-plated copper alloy, a tin-plated copper alloy, or the like may be used as the metallic wires.

The provision of the shield layer 15 allows signal leakage to the outside and radio wave penetration from the outside to be suppressed.

### (1-1-5) Release Material

The cable 10 of the present embodiment may have a release material 16 outside the core 10A. An example of the release material 16 may be a tape composed of an insulating material such as paper, a nonwoven fabric, or a resin such as polyester helically wound around the core 10A. Another example of the release material 16 may be a powder such as talc applied to the outer periphery of the core 10A.

The provision of the release material 16 outside the core 10A serves to prevent the core 10A and the outer sheath 17 from coming into direct contact with each other. As a result, the outer sheath 17 may easily be removed at the longitudinal end of the cable 10 when the covered electric wires are taken out.

When the release material 16 is formed by winding a tape around the outer periphery of the core 10A, the winding direction of the tape may be freely selected. The winding direction may be the same direction as, or a different direction from, the twist direction of the core 10A previously described. In particular, the twist direction of the core 10A and the winding direction of the tape are preferably in the same direction.

As illustrated in FIG. 1, when the cable 10 includes the interposition 14 and the shield layer 15, the release material 16 may be arranged outside the shield layer 15, and the outer sheath 17 may be arranged to cover the release material 16.

The cable of the present embodiment may be used in various applications in which the cable may be repeatedly bent by a force applied thereto. The cable of the present embodiment is suitable for applications in which the cable is routed near a tire of an automobile. In particular, the cable may be suitably used for applications in which the consequences possibly resulting from breaking of a covered electric wire is significant and the breaking of a covered electric wire is particularly required to be suppressed, as in an electric brake system in which a foot brake of an automobile is implemented as an electrical system. In the electric brake system, the second covered electric wires are configured to supply electric power for driving an actuator, and the first covered electric wires are configured to transmit electric signals related to the control of the actuator and electric signals related to the rotational speed of the wheels.

### (1-2) Second Embodiment

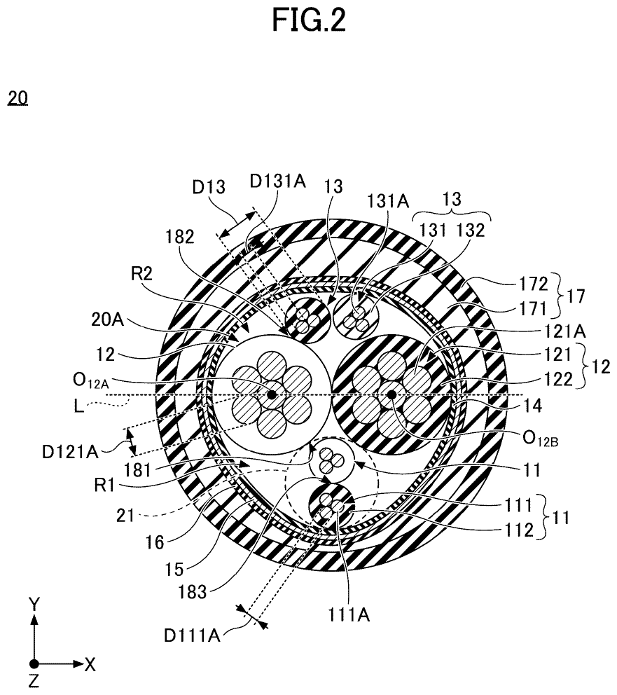

Another embodiment of the cable will be described with reference to FIG. 2. FIG. 2 illustrates a cross-sectional view in a plane perpendicular to the longitudinal direction of a cable 20 of the present embodiment. In FIG. 2, the Z-axis direction, i.e., the direction perpendicular to the paper plane, is the longitudinal direction of the cable or covered electric wires, and the XY plane is the plane perpendicular to the longitudinal direction of the cable or the like.

### (1-2-1) Covered Electric Wire

### (First Covered Electric Wire to Third Covered Electric Wire)

In the cable 20 illustrated in FIG. 2, a plurality of covered electric wires may include two first covered electric wires 11, two second covered electric wires 12, and two third covered electric wires 13. The two first covered electric wires 11 may be constituted by the same members, and may have the same conductor cross-sectional area and the like. The same applies to the two second covered electric wires 12 and the two third covered electric wires 13.

Descriptions are omitted here with respect to the electric wires which can be constructed in substantially the same manner as in the cable 10.

Unlike the cable 10, the two third covered electric wires 13 may be arranged in substantially parallel. The substantially parallel arrangement means that the two third covered electric wires 13 are arranged adjacent to each other without being twisted.

The third covered electric wires 13 may be used as bend detection wires to detect the bending of the cable 20. The principle of bend detection is the same as that described in the first embodiment. In the cable of the second embodiment, compared with the cable of the first embodiment, the distance between the two third covered electric wires is easily increased, with the two third covered electric wires being not bound to each other. It is thus easy to detect changes in the impedance of the two third covered electric wires.

### (Core)

The cable 20 differs from the cable 10 of the first embodiment in that the two third covered electric wires 13 are not twisted together. The contact point between the third covered electric wires 13 and the second covered electric wires 12 may be provided as a contact between any one of the two third covered electric wires 13 and any one of the second covered electric wires 12. The other configurations are the same as those of the cable 10 of the first embodiment, and descriptions thereof will be omitted.

### (1-2-2) Cover

The cable 20 may include an outer sheath 17 arranged to cover the core 20A. The outer sheath 17 may be constructed in substantially the same manner as in the cable 10 of the first embodiment, and a description thereof will be omitted.

### (1-2-3) Interposition

The cable 20 of the present embodiment may also include an interposition 14 outside the core 20A. The interposition 14 may be constructed in substantially the same manner as in the first embodiment, and a description thereof will be omitted.

### (1-2-4) Shield Layer

As illustrated in FIG. 2, the cable 20 of the present embodiment may also include a shield layer 15 covering the core 20A. The shield layer 15 may be constructed in substantially the same manner as in the first embodiment, and a description thereof will be omitted.

### (1-2-5) Release Material

The cable 20 of the present embodiment may have a release material 16 outside the core 20A. The release material 16 may be constructed in substantially the same manner as in the first embodiment, and a description thereof will be omitted.

### (2) Bend Count Detection Device

As illustrated in FIG. 4, a bend count detection device 40 of the present embodiment may include a cable 42, which is the aforementioned cable 10 or cable 20, and a measurement device 41 connected to the conductors of the third covered electric wires 13 included in the cable 42. The measurement device 41 may be configured to apply inspection signals inclusive of an AC component to the third covered electric wires and to measure the impedance of the third covered electric wires.

In addition to measuring impedance, the measurement device 41 may count the number of times the cable is bent.

Impedance may be measured by inputting inspection signals inclusive if an AC component into the conductors of the two third covered electric wires 13 as described above, and measuring the impedance between the two conductors as a response signal. The response signal is acquired by a reflection method or a transmission method. An LCR meter or the like is an example of the measurement device.

The reference value for determining whether the cable is bent may be set based on the measured value of a change in impedance observed when the cable is bent. For example, an impedance change observed when the third covered electric wires are bent is measured in advance, followed by obtaining the relationship between the impedance change and the bending angle. For example, an impedance change of A (Ω) is observed when the bending angle of the third covered electric wires is α degrees, and, then, the arrangement is made such that the bending of the third covered electric wires is detected when the third covered electric wires are bent at an angle of α degrees or more. The occurrence of a change in the impedance of the third covered electric wires by A (Ω) or more then causes an increment in the count indicating that the cable is bent once.

The bend count detection device 40 of the present embodiment may also include a notification device. The notification device receives a signal indicative of the outcome of measurement from the measurement device 41. When the number of bends counted by the measurement device 41 exceeds a threshold, a notice may indicate that the number of bends exceeds the threshold, and that the time to replace the cable has arrived.

The specific method of notification to the outside is not limited to a particular one, but examples include a display device such as a display panel or a warning lamp, a transmitter such as a buzzer, and a control device for interlocking.

### (3) Specific Examples of Configuration of Cable

Specific examples of the configuration of the cable will be described below. It should be noted, however, that the present invention is not limited to these examples.

### Example 1

The cable 10 illustrated in FIG. 1 includes, as covered electric wires, the two first covered electric wires 11, the two second covered electric wires 12 having a conductor cross-sectional area larger than that of the first covered electric wires 11, and the two third covered electric wires 13 having a conductor cross-sectional area smaller than that of the second covered electric wires 12.

The two first covered electric wires 11 are twisted together along the longitudinal direction to form the first twisted wire pair 21, and the two third covered electric wires 13 are twisted together along the longitudinal direction to form the second twisted wire pair 22.

The twist pitch of the second twisted wire pair 22 is set to 80 mm, and is longer than the twist pitch of the first twisted wire pair 21 which is 35 mm. The outer diameter D13 of each third covered electric wire 13 contained in the second twisted wire pair 22 is 1 mm, so that the twist pitch of the second twisted wire pair 22 is 80 times the outer diameter D13 of the third covered electric wire 13.

The first twisted wire pair 21, the two second covered electric wires 12, and the second twisted wire pair 22 are twisted together to form the core 10A. In the core 10A, at least a partial contact is provided between the first covered electric wires 11 and the second covered electric wires 12, between the second covered electric wires 12 and the third covered electric wires 13, and between the two first covered electric wires 11.

The interposition (PET tape) 14 is wound around, and covers, the outer surface of the core 10A, and the shield layer 15 is arranged to cover the outer surface of the interposition 14. The release material 16 is arranged on the outer surface of the shield layer 15.

The outer sheath 17 is arranged to cover the outer surface of the core 10A, specifically to cover the outer surface of the release material 16.

### Example 2

The cable 20 illustrated in FIG. 2 includes, as covered electric wires, the two first covered electric wires 11, the two second covered electric wires 12 having a conductor cross-sectional area larger than that of the first covered electric wires 11, and the two third covered electric wires 13 having a conductor cross-sectional area smaller than that of the second covered electric wires 12.

The two first covered electric wires 11 are twisted together along the longitudinal direction to form the first twisted wire pair 21. The two third covered electric wires 13 are arranged in parallel and provided in an untwisted form.

The first twisted wire pair 21, the two second covered electric wires 12, and the two third covered electric wires 13 are twisted to form the core 20A. In the core 20A, at least a partial contact is provided between the first covered electric wires 11 and the second covered electric wires 12, between the second covered electric wires 12 and the third covered electric wires 13, and between the two first covered electric wires 11.

The interposition (paper tape) 14 is wound around, and covers, the outer surface of the core 20A, and the shield layer 15 is arranged to cover the outer surface of the interposition 14. The release material 16 is arranged on the outer surface of the shield layer 15.

The outer sheath 17 is arranged to cover the outer surface of the core 20A, specifically, to cover the outer surface of the release material 16, and has a two-layer structure with the inner layer 171 and the outer layer 172.

### DESCRIPTION OF THE CODE

10, 20, 42 Cable
10 A, 20 A Core
11 First covered electric wire
111A Element conductor wire
D111A Conductor wire diameter
111 Conductor
112 Insulator
21 First twisted wire pair
12 Second covered electric wire
121A Element conductor wire
D121A Conductor wire diameter
121 Conductor
122 Insulator
O_{12A}, O_{12B} Center
L Straight line
R1 First region
R2 Second region
13 Third covered electric wire
D13 Outer diameter
131A Element conductor wire
D131A Conductor wire diameter
131 Conductor
132 Insulator
22 Second twisted wire pair
14 Interposition
15 Shield layer
16 Release material
17 Outer Sheath
171 Inner layer
172 Outer layer
181, 182, 183 Contact
30 Twisted strand
31 First covered electric wire
32 A, 32B Second covered electric wire
33 Third covered electric wire
CA central axis
Pt twist pitch
40 Bend count detection device
41 Measurement device

1. A cable comprises: a plurality of covered electric wires; and an outer sheath,
wherein the plurality of covered electric wires include:
two first covered electric wires;
two second covered electric wires having a larger conductor cross-sectional area than the first covered electric wires; and
two third covered electric wires having a smaller conductor cross-sectional area than the second covered electric wires, and
wherein the two first covered electric wires are twisted together along a longitudinal direction thereof to form a first twisted wire pair,
the two third covered electric wires are twisted together along a longitudinal direction thereof to form a second twisted wire pair,
a twist pitch of the second twisted wire pair is longer than a twist pitch of the first twisted wire pair,
the first twisted wire pair, the two second covered electric wires, and the second twisted wire pair are twisted together to form a core,
in the core, at least a partial contact is provided between the first covered electric wires and the second covered electric wires, between the second covered electric wires and the third covered electric wires, and between the two first covered electric wires, and
the outer sheath is arranged to cover the core.

2. The cable as claimed in claim 1, wherein a twist direction of the second twisted wire pair is different from a twist direction of the core.

3. The cable as claimed in claim 1, wherein the twist pitch of the second twisted wire pair is longer than a twist pitch of the core.

4. The cable as claimed in claim 1, wherein the twist pitch of the second twisted wire pair is greater than or equal to 50 times an outer diameter of each of the third covered electric wires.

5. A cable comprising: a plurality of covered electric wires; and an outer sheath;
wherein the plurality of covered electric wires include:
two first covered electric wires;
two second covered electric wires having a larger conductor cross-sectional area than the first covered electric wires; and
two third covered electric wires having a smaller conductor cross-sectional area than the second covered electric wires, and
wherein the two first covered electric wires are twisted together along a longitudinal direction thereof to form a first twisted wire pair, and
the first twisted wire pair, the two second covered electric wires, and the two third covered electric wires are twisted together to form a core,
wherein in the core,
the two third covered electric wires are arranged in substantially parallel, and
at least a partial contact is provided between the first covered electric wires and the second covered electric wires, between the second covered electric wires and the third covered electric wires, and between the two first covered electric wires, and
wherein the outer sheath is arranged to cover the core.

6. The cable as claimed in claim 1, wherein in a cross-section perpendicular to a longitudinal direction,
when the cross-section is divided into a first region and a second region by a straight line connecting centers of the two second covered electric wires,
the two first covered electric wires are arranged in the first region and the third covered electric wires are arranged in the second region.

7. The cable as claimed in claim 1, further comprising a shield layer covering the core,
wherein the outer sheath is arranged to cover the shield layer.

8. The cable as claimed in claim 1, further comprising a release material disposed outside the core.

9. The cable as claimed in claim 1, wherein the two third covered electric wires are bend detection lines that detect bending of the cable.

10. The cable as claimed in claim 5, wherein the two third covered electric wires are bend detection lines that detect bending of the cable.

11. The cable as claimed in claim 1, wherein bending of the cable is detectable based on a change in impedance of the two third covered electric wires.

12. The cable as claimed in claim 5, wherein bending of the cable is detectable based on a change in impedance of the two third covered electric wires.
